(19) United States
(12) Patent Application Publication
(10) Pub. No.: US 2021/0035711 A1
(43) Pub. Date: Feb. 4, 2021

(54) Underground Layable Power Cable, In Particular, a Submarine Cable

(71) Applicant: Sebastian Obermeyer, Hamburg (DE)

(72) Inventor: Sebastian Obermeyer, Hamburg (DE)

(73) Assignee: RWE Renewables GmbH, Essen (DE)

(21) Appl. No.: 17/075,118

(22) Filed: Oct. 20, 2020

Related U.S. Application Data
(63) Continuation of application No. PCT/EP2019/058480, filed on Apr. 4, 2019.

(30) Foreign Application Priority Data
Apr. 20, 2018 (DE) 10 2018 109 550.3

(51) Int. Cl. H01B 7/32; H01B 5/10; H01B 9/00; H01B 3/47

(52) U.S. Cl. CPC H01B 7/324; H01B 3/47; H01B 9/005; H01B 5/105

(57) ABSTRACT

An underground layable power cable, in particular a submarine cable, having at least one phase conductor and at least one optical fiber conductor. The optical fiber conductor is integrated in the phase conductor. The optical fiber conductor may include at least one optical fiber. Further, the optical fiber may be surrounded by at least one protective layer, which may be formed from a plastic-gel combination. The gel may at least one of a silicone gel, a glass fiber material, or a carbon fiber material.

### CROSS-REFERENCE TO RELATED PATENT APPLICATIONS

This patent application is a continuation of PCT/EP2019/058480, filed Apr. 4, 2019, which claims the benefit of German Patent Application No. DE 10 2018 109 550.3, filed Apr. 20, 2018, the entire teachings and disclosure of which are incorporated herein by reference thereto.

### FIELD

The application relates to an underground layable power cable, in particular, a submarine cable, comprising at least one phase conductor and at least one optical fiber conductor. In addition, the application relates to a method of manufacturing an underground layable power cable.

### BACKGROUND

Wind energy systems with at least one wind turbine are increasingly used to provide electrical energy from renewable energy sources. A wind power plant is configured, in particular, to convert the kinetic wind energy into electrical energy. In order to increase the energy output of such systems, wind energy systems are installed at locations with a high wind probability. Offshore sites in particular are usually characterized by relatively continuous wind conditions and high average wind speeds, so that so called offshore wind energy systems and offshore wind farms, respectively, are increasingly installed.

An offshore wind energy system typically has a plurality of offshore devices, such as a plurality of wind turbines and at least one offshore substation, through which the offshore wind energy system is electrically connected to an onshore substation. The onshore substation, in turn, may be connected to a public power grid. To transfer electrical energy between two offshore devices, medium or high voltage cables are laid in the form of submarine cables.

Such a submarine cable, but also other medium or high voltage cables that can be laid underground, comprise at least one phase conductor to allow current to flow through the submarine cable. An exemplary submarine cable 100 according to the state of the art is shown in FIG. 1.

In the exemplary submarine cable 100, the phase conductor 102 (e.g. made of copper or aluminum) is surrounded by an (electrical) insulating layer 104. The insulating layer 104 is, in turn, surrounded by a shielding layer 106 of an electrically conductive material (e.g. copper or aluminum). Furthermore, today's submarine cables 100 contain an optical fiber conductor 110 as a temperature sensor 110. Between the phase conductor 102 and the insulating layer 104 an inner (not shown) semiconductor layer may be arranged. In addition, an outer (not shown) semiconductor layer may be arranged between the insulating layer 104 and the shielding layer 106.

The outer surface of the submarine cable 100 is formed by an outer sheath 108, wherein the area between the outer sheath 108 and the shielding layer 106 is filled with a filling material 112 to provide a submarine cable 100 with a substantially circular outer wall. In particular, the filler material 112 is capable of compensating unevenness. The outer sheath 108 may contain steel wires which can absorb the tensile forces during installation and/or operation. In this way the submarine cable 100 can be protected from damages.

In principle, an optical fiber conductor enables a spatially resolved determination of the temperature of the immediate vicinity of the optical fiber conductor. However, since the warmest point of a previously described underground power cable lies in the (circular) center of the phase conductor and the optical fiber conductor is located at the outer sheath, the temperature measured or sensed by the optical fiber conductor does not correspond to the actual temperature of the power cable. In the present application, the actual temperature of the power cable is the temperature at the warmest point of the power cable, i.e. the core temperature of the phase conductor.

In order to determine this actual temperature of the power cable, according to the state of the art, the actual temperature in the center of the phase conductor is determined, in particular, calculated, based on the measured temperature and complex calculation algorithms (computer-aided). A particular problem here is that the calculation algorithms have to be adapted for each cable type and each environmental condition or different environmental conditions (e.g. different laying depth, which also changes in the course of a laid power cable, different environmental materials (e.g. sand, gravel, sand gravel, water, steel pipe, exposed etc.). For the cable type, the distance to the phase conductor center, the materials in between (and their thicknesses), the outer sheath used etc. must be taken into account in particular. As a result, the calculation algorithms have to be determined anew for each power cable to be laid, and in particular, a large number of different calculation algorithms have to be determined due to the changing environmental conditions along a laid power cable.

In spite of the great effort required in the state of the art for a correct determination of the temperature of the phase conductor center of a phase conductor, tests show that in practice the temperatures determined with the calculation algorithms are not sufficiently accurate. In particular, certain temperature values can differ considerably from the actual temperature values of a power cable. The reasons for this can be, for example, incorrect assumptions about the ambient conditions, faulty algorithms and/or the like.

Therefore, the object of the application is to provide an underground layable power cable, in particular, a submarine cable, where the actual temperature of the power cable can be determined with a greater accuracy and at the same time by simpler means.

### BRIEF SUMMARY

The object is solved, according to a first aspect of the application, by an underground layable power cable, in particular, a submarine cable, according to the present disclosure. The power cable comprises at least one phase conductor. The power cable comprises at least one optical fiber conductor. The optical fiber conductor is integrated in the phase conductor.

Contrary to the state of the art, according to the application, the optical fiber conductor is integrated in the phase conductor of a power cable, and thereby, the accuracy of the temperature determination of the actual (maximum) temperature of the power cable is determined in a simple way. Due to the integration in the phase conductor, complex and computer-aided calculation algorithms can be dispensed with or at least their number and/or complexity can be significantly reduced. In addition, when determining the temperature, it is not necessary to consider the respective cable type and/or the respective ambient conditions.

An underground layable power cable is a power cable that is basically designed for underground installation, i.e. not open-air. Exemplified and non-exhaustive examples of power cables are underground cables and submarine cables. However, overhead lines and overhead cables, respectively, do, in particular, not fall under the scope of a power cable in accordance with the application.

In addition, the power cable according to the application is configured to transmit electrical energy and power, respectively. A communication cable configured exclusively for the transmission of messages and information, respectively, does not fall under the scope of a power cable in accordance with the application.

For the transmission of energy (or power or current), a power cable in accordance with the application comprises at least one phase conductor, in particular, three phase conductors, made of an electrically conductive material. Preferably, the phase conductor can be made of metal, in particular, copper or aluminum.

The power cable also comprises at least one optical fiber conductor. The optical fiber conductor is formed at least as a (linear) temperature sensor. The optical fiber conductor is, in particular, a temperature sensor of a temperature measuring arrangement. The temperature measuring arrangement can be configured to determine the (instantaneous and/or spatially resolved) temperature of the power cable. The optical fiber conductor (together with the temperature measuring arrangement) is, in particular, configured to detect and measure, respectively, the temperature of the phase conductor (in a spatially resolved way). In particular, the heating of the optical fiber conductor causes reflections of the light in the optical fiber conductor. These reflections can be detected by the temperature measurement arrangement at the end of the optical fiber conductor and then output e.g. as a temperature value.

The optical fiber conductor is integrated in the phase conductor according to the application. In particular, the phase conductor can be composed of at least two phase conductor elements. The at least two phase conductor elements can at least partially enclose and surround, respectively, the optical fiber conductor. As the optical fiber conductor is (almost) directly adjacent to the phase conductor due to its integration in the phase conductor, the actual phase conductor temperature can be (directly) measured. Further calculation steps can be omitted or can at least be less complex.

According to a first embodiment of the power cable according to the present application, the phase conductor may comprise a substantially circular cross-section. The optical fiber conductor can be arranged in the (circular) center of the phase conductor. In other words, the at least one optical fiber conductor can essentially form the central axis of the phase conductor. By integrating the optical fiber conductor, in particular, by arranging the optical fiber conductor at the center of the phase conductor, the maximum (actual) temperature of the phase conductor can be measured in a particularly accurate manner. For example, a power cable and the at least one phase conductor, respectively, heats up most when current flows in the phase conductor core.

In principle, the phase conductor can be formed in any way as long as the optical fiber conductor can be integrated into the phase conductor. Preferably, the phase conductor can be formed from at least two phase conductor elements.

According to a preferred embodiment of the power cable according to the present application, the phase conductor may be a phase conductor selected from the group comprising:
a segment conductor (also called a “segmented conductor”) with at least two segments,
a stranded phase conductor (also called a “stranded conductor”),
a compressed phase conductor (also called a “compressed round conductor”),
a profiled phase conductor (also called “profiled conductor”), and
a compacted phase conductor (also called a “compacted conductor”).

With such phase conductors, the optical fiber conductor can be integrated into the phase conductor in a particularly simple way.

In addition, according to a further embodiment, the at least one optical fiber conductor may comprise at least one optical fiber. The optical fiber may be surrounded by at least one protective layer, in particular, a protective tube. The at least one optical fiber may be a monomode fiber or a multimode fiber. The at least one optical fiber is configured at least to detect the temperature of the phase conductor. Preferably, the optical fiber conductor may be formed by several optical fibers. In this case, the optical fiber conductor may be configured in addition to transmit data sets and information, respectively (e.g. between two offshore facilities).

In addition to the at least one optical fiber, an optical fiber conductor may comprise at least one protective layer. The protective layer may surround and enclose, respectively, the at least one optical fiber. The protective layer can be formed, in particular, by a protective tube.

In a preferred embodiment of the power cable according to the present application, the protective layer may be formed of a plastic material and/or a gel material, in particular, a silicone gel, and/or a glass fiber material and/or a carbon fiber material and/or the material from which the phase conductor is formed. A plastic-gel combination can preferably be used. In particular, different plastics materials can be used in combination with different gels. The at least one gel may be placed above and/or below a layer of plastic material, in particular, a protective tube formed of plastic material. A reduction of the forces generated by the at least one phase element of the phase conductor, which can act on the optical fiber and/or the protective layer, can be achieved.

Alternatively, in particular a tube made of glass or carbon fiber can be used as a protective layer for the at least one optical fiber. Preferably, a tube can be used as a protective layer, which is made of the same material (e.g. copper or aluminum) as the phase conductors in which the optical fiber is integrated.

It goes without saying that the at least one plastic material and/or the at least one gel material should meet the mechanical and thermal (at least 90° C.) requirements that must be met in a power cable.

High density polyethylene (HDPE) may be the preferred plastic material. It has been recognized that a suitable plastic material fulfils the requirements of a power cable, in particular, a submarine cable, particularly well.

In order to achieve easy integration and to minimize the influence on the current flow through the phase conductor, the (outer) diameter of the protective layer (in particular the protective tube) of the optical fiber conductor can be between 0.5 mm and 5 mm, preferably between 1 mm and 2.5 mm, according to a preferred embodiment.

As described above, a power cable can have a single phase conductor. In order to enable current to flow over three phases in such a power cable, three power cables with one phase conductor each can be laid in parallel.

Alternatively, according to a further embodiment, the power cable may comprise three phase conductors. An optical fiber conductor can be integrated in each of the three phase conductors. The phase conductors can each be surrounded by an insulation layer, a shielding layer etc. In addition, a common outer cable sheath can be provided, wherein cavities can be filled with a filling material, for example. In this way, a three-phase power cable with optimized temperature monitoring can be provided for all phase conductors.

As already described, the power cable according to the application is configured to transmit power and energy, respectively. This means, according to a preferred embodiment of the power cable according to the application, that the power cable is a medium voltage cable or a high voltage cable.

A further aspect of the application is a method of manufacturing an underground layable power cable, in particular, a power cable, as described above. The method comprises:
providing an optical fiber conductor, and
enclosing the provided optical fiber conductor with at least two phase conductor elements of a phase conductor, such that a phase conductor with an integrated optical fiber conductor is manufactured.

The method as described in the application enables the production of a power cable with improved temperature monitoring capability. In particular, the power cable can be manufactured in a simple manner. For example, a provided optical fiber conductor can be integrated into a phase conductor by wrapping or surrounding the optical fiber conductor with at least two phase conductor elements.

In particular, the enclosing of the provided optical fiber conductor with at least two phase conductor elements of a phase conductor may comprise the wrapping of the provided optical fiber conductor with at least two phase conductor elements of a phase conductor.

The provision of the phase conductor may, in particular, comprise the enclosing or provision of at least one optical fiber with at least one protective layer. The optical fiber(s) may be produced first. Subsequently, the at least one optical fiber may preferably be provided with the plastic and/or gel layer. After this step, the phase conductor elements (e.g. the cable cores) can be wound around the appropriately provided optical fiber conductor.

A further aspect of the application is an offshore wind energy system and offshore wind farm, respectively, comprising:
a first offshore device (e.g. a substation or a wind turbine) and at least one further offshore device (e.g. a substation or a wind turbine),
wherein the first offshore device is electrically connected to the further offshore device by at least one submarine cable as described above.

The characteristics of the power cable and the method can be freely combined. In particular, features of the description and/or the dependent claims, even by completely or partially circumventing features of the independent claims, may be independently inventive, either alone or freely combined.

There is now a wide range of possibilities to design and develop the power cable and the method according to the application. For this purpose, reference is made on the one hand to the patent claims subordinate to the independent patent claims, and on the other hand to the description of design examples in connection with the drawing. In the drawing shows:

### BRIEF DESCRIPTION OF THE DRAWINGS

FIG. 1 is a schematic view of a power cable according to the state of the art,

FIG. 2 is a schematic view of an embodiment of a power cable according to the present application,

FIG. 3 is a schematic view of a further embodiment of a power cable according to the present application,

FIG. 4 is a schematic view of a further embodiment of a power cable according to the present application,

FIG. 5 is a schematic view of a further embodiment of a power cable according to the present application,

FIG. 6 is a schematic view of a further embodiment of a power cable according to the present application,

FIG. 7 is a schematic view of a further embodiment of a power cable according to the present application,

FIG. 8 is a schematic view of a further embodiment of a power cable according to the present application,

FIG. 9 is a diagram of an embodiment of a method according to the present application, and

FIG. 10 is a schematic view of a further embodiment of a power cable according to the present application.

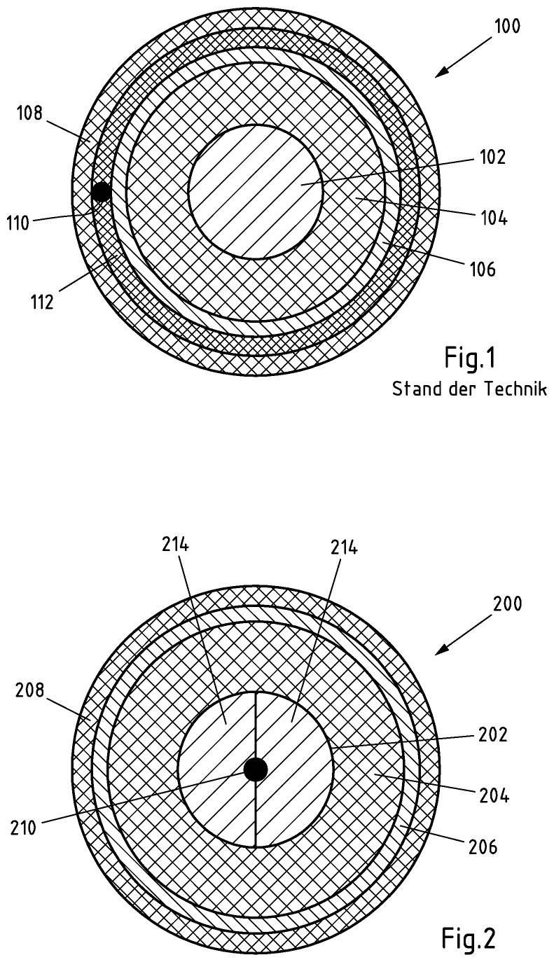

### DETAILED DESCRIPTION

In the figures, the similar reference signs are used for same elements.

FIG. 2 shows a schematic view of an embodiment of a power cable 200 according to the present application. The illustrated underground layable power cable 200 may, in particular, be a submarine power cable 200. Preferably the power cable 200 is a medium voltage cable or a high voltage cable. For example, the submarine power cable 200 may be laid between a first (not shown) offshore device and a further (not shown) offshore device.

The power cable 200 comprises at least one phase conductor 202, which is formed by two phase conductor elements 214 in the form of two phase conductor segments 214.

As can be seen, an optical fiber conductor 210 is integrated in the phase conductor 202. The phase conductor 202 preferably has an essentially circular cross-section. The optical fiber conductor 210 is arranged, in particular, in the center of the phase conductor. In other words, the optical fiber conductor 210 in the phase conductor 202 runs through the middle or central axis of the phase conductor.

By means of a fiber optical temperature measurement, in particular, temperature changes in a power cable 200 can be determined via optical fiber conductor. One or more optical fiber(s) is/are used as sensors, which allow an exact local assignment of the temperature and reflect changes in temperature and pressure on the fiber. Due to the physical changes at the points where the temperature rises or the pressure on the fiber changes, reflections occur which contain components of different wavelengths in their backscattering. These scatterings can be roughly divided into Rayleigh scattering, Ramann scattering and Brillouin scattering. While Rayleigh scattering is not temperature dependent, Ramann and Brillouin scattering are temperature dependent scatterings which, unlike Rayleigh scattering, are spectrally shifted (so-called “Stoke” and “Anti Stoke” bands). Anti-Stoke bands are even more temperature dependent and are therefore preferably used for temperature measurements.

The at least one fiber optical conductor 210 installed in the power cable 200 can be led in a ring connection (or with open end) to a corresponding (not shown) temperature measuring facility.

By integrating at least one optical fiber 210 directly in the phase conductor 202, the actual temperature, i.e. in particular the maximum temperature of the power cable 200, can be measured. In particular, this can be done independently of the type of cable and/or ambient conditions. If necessary, it may be necessary to consider an optional protective coating when determining the actual cable temperature.

As an example, the power cable 200 has an (electrical) insulation layer 204 around the phase conductor 202, a shielding layer 206 (e.g. of copper) and an outer cable sheath 208. Furthermore, (not shown) filling material may be provided to compensate unevenness if necessary. Between the phase conductor 202 and the insulating layer 204 an inner (not shown) semiconductor layer may be provided. In addition, an outer (not shown) semiconductor layer may be arranged between the insulating layer 204 and the shielding layer 206. The outer sheath 208 may contain steel wires that can absorb the tensile forces during installation and/or operation. In this way the submarine cable 200 can be protected from damages.

It shall be understood that according to other variants of a power cable according to the application, other layer orders may be provided as long as the at least one optical fiber conductor is integrated in the at least one phase conductor.

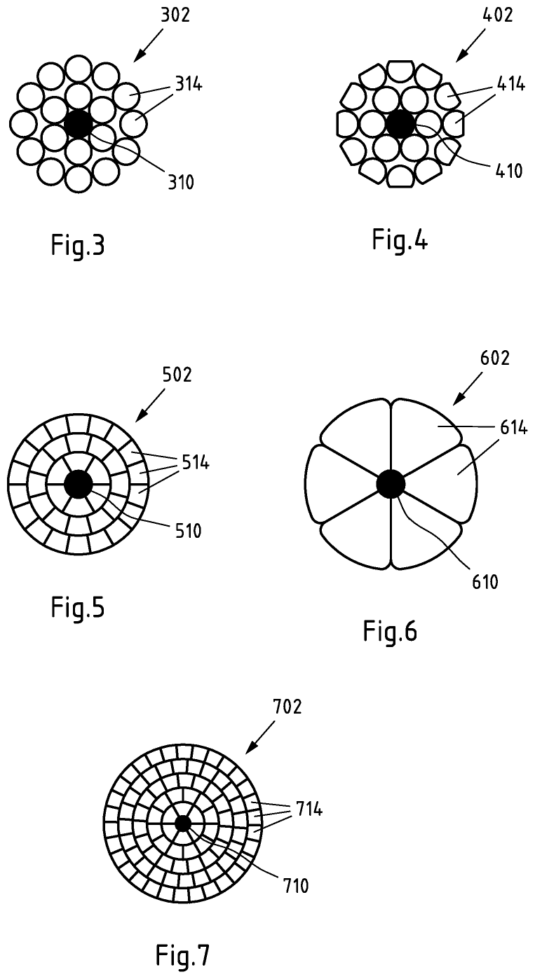

FIGS. 3 to 7 show schematic views of various embodiments of power cables with different (exemplary) types of phase conductors 302 to 702, but it should be noted that for a better overview only the phase conductors are shown. It goes without saying that a power cable as shown in FIGS. 3 to 7 may have further layers, such as insulating layer, shielding layer, inner and outer semi-conducting layer, outer sheath, filling material etc., in accordance with the explanations in FIG. 2

FIG. 3 shows a stranded phase conductor 302. The optical fiber conductor 310 arranged in the central axis of the phase conductor 302 is surrounded, and in particular, wrapped, by a large number of phase conductor elements 314 in the form of stranded conductors 314.

In addition, FIG. 4 shows a pressed and compressed, respectively, phase conductor 402 (also called “compressed round conductor”). A plurality of phase conductor elements 414 can surround the at least one optical fiber conductor 410 in a compressed form.

FIG. 5 shows a profiled phase conductor 502 (also called “profiled conductor”), in which a large number of profiled phase conductor elements 514 are wound around at least one optical fiber conductor 510.

As can be seen in FIG. 6, a phase conductor 602 can be formed as a segment conductor 602 (also called a “segmented conductor”). Such a segmented conductor 602 can comprise at least two phase conductor elements 614 in the form of segments 614. Six segments 614 are provided, which surround the at least one optical fiber conductor 610.

FIG. 7 shows a compacted conductor 702 with a plurality of phase conductor elements 714 surrounding at least one optical fiber conductor 710.

It shall be understood that a phase conductor may be formed differently according to other variants of the application.

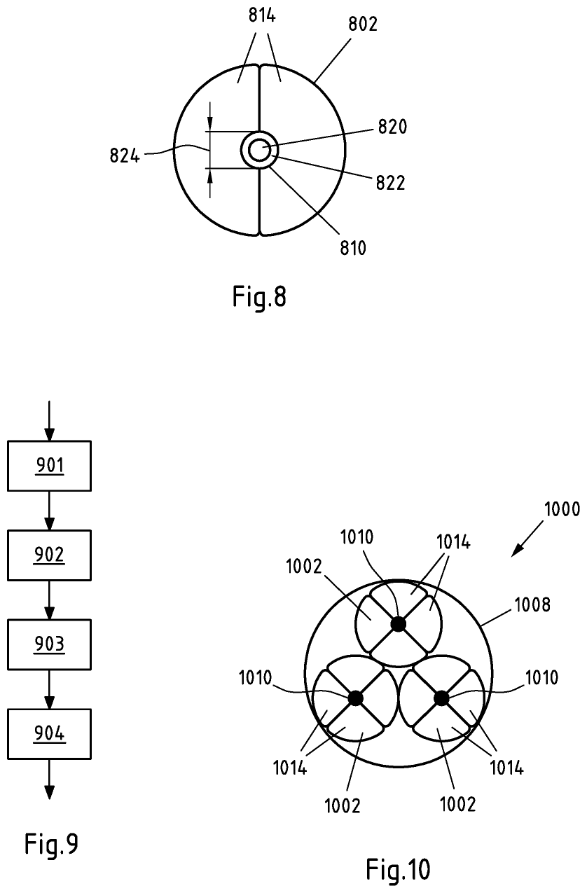

FIG. 8 shows a schematic view of a further embodiment of a power cable 800 according to the present application. In order to avoid repetition, only the differences to the embodiments according to the previous FIGS. 2 to 7 are essentially described below. For the other components of the power cable 800 we refer in particular to the above explanations.

The optical fiber conductor 810 shown in FIG. 8 comprises at least one optical fiber 820 (e.g. a single mode fiber or a multimode fiber), in particular, a plurality of optical fibers 820, and at least one protective layer 822. The optical fiber conductor may be configured for temperature measurement and, in particular, for information transmission.

The protective layer 822 can surround the at least one optical fiber 820 and can be formed as protective tube 822, for example. Preferably, the protective layer 822 can be formed from a plastic-gel combination. In other variants of the application, the protective layer 822 can be used as a protective tube formed from glass fiber, carbon fiber or the phase conductor material (e.g. copper or aluminum).

The optical fiber 810 can have a diameter 824 between 0.5 mm and 5 mm, preferably between 1 mm and 2.5 mm.

FIG. 9 shows an exemplary diagram of a method for manufacturing a power cable according to the present application. In particular, the method described can be used to manufacture a power cable according to an embodiment shown in FIGS. 2 to 8.

First, in step 901, at least one optical fiber can be provided (e.g. produced) for the production of an optical fiber conductor in accordance with the application.

The optical fiber can be provided with a protective layer in step 902. For example, the optical fiber can be inserted into a (plastic) tube and/or be coated with a protective layer.

In step 903, the manufactured optical fiber conductor can be provided for further processing. Then, in step 904, the provided optical fiber conductor can be enclosed (sheathed) with at least two phase conductor elements of a phase conductor in such a way that a phase conductor with an integrated optical fiber conductor is manufactured. In particular, in this step the phase conductor elements (e.g. cable cores) can be wound around the correspondingly provided optical fiber conductor.

In a simple way, a power cable that can be laid underground in accordance with the application, in particular, a submarine cable, can be manufactured.

FIG. 10 shows a schematic view of an embodiment of a power cable 1000 according to the present application. The illustrated underground layable power cable 1000 may, in particular, be a submarine power cable 1000. Preferably, the power cable 1000 is a medium voltage cable or a high voltage cable. In order to avoid repetition, only the differences to the embodiments according to the previous FIGS. 2 to 8 are described below. For the other components of the power cable 1000, we refer in particular to the above explanations.

The power cable 1000 shown here comprises three phase conductors 1002, each with a plurality of phase conductor segments 1014. In particular, the outer sheath 1008 encloses the three phase conductors 1002.

An optical fiber conductor 1010 is integrated in each of the phase conductors 1002. This allows the temperature of each phase conductor of the power cable 1000 to be monitored.

It should be noted that for a better overview only phase conductors 1002 are shown. It goes without saying that the power cable as shown in FIG. 10 can have other layers, such as insulating layers, shielding layers, inner and outer semiconductor layers, filling material, etc., in accordance with the explanations in FIG. 2.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An underground layable power cable, wherein the power cable is a submarine cable, and wherein the power cable is a medium voltage cable or a high voltage cable, comprising
at least one phase conductor, and
at least one optical fiber conductor formed as a temperature sensor,
wherein the optical fiber conductor is integrated in the phase conductor,
wherein the optical fiber conductor comprises at least one optical fiber,
wherein the optical fiber is surrounded by at least one protective layer,
wherein the protective layer is formed from a plastic-gel combination, wherein the gel is a silicone gel, and/or a glass fiber material and/or a carbon fiber material.

2. The power cable according to claim 1, wherein the phase conductor comprises a substantially circular cross-section and the optical fiber conductor is arranged in the center of the phase conductor.

3. The power cable of claim 1, wherein the phase conductor is a phase conductor selected from the group consisting of:
a segment manager with at least two segments,
a stranded phase conductor,
a pressed phase conductor,
a profiled phase conductor, and
a compressed phase conductor.

4. The power cable according to claim 1, wherein the optical fiber is surrounded by at least one protective layer in form of a protective tube.

5. The power cable according claim 1, wherein the protective layer is formed from a plastic-gel combination and the plastic material is high density polyethylene.

6. The power cable according to claim 1, wherein the diameter of the protective layer is between 0.5 mm and 5 mm.

7. The power cable according to claim 6, wherein the diameter of the protective layer is between 1 mm and 2.5 mm.

8. The power cable according to claim 1, wherein the power cable comprises three phase conductors and an optical fiber conductor is integrated in each of the three phase conductors.

9. A method for manufacturing a power cable according to claim 1, comprising:
providing an optical fiber conductor, and
enclosing the optical fiber conductor with at least two phase conductor elements of a phase conductor, such that a phase conductor with an integrated optical fiber conductor is manufactured.

10. An offshore wind energy system, comprising:
a first offshore device and at least one further offshore device,
wherein the first offshore device is electrically connected to the further offshore device by at least one power cable according to claim 1.
